(19) United States
(12) Patent Application Publication
(10) Pub. No.: US 2013/0219499 A1
(43) Pub. Date: Aug. 22, 2013

(54) APPARATUS AND METHOD FOR PROVIDING SECURITY FOR VIRTUALIZATION

(71) Applicants: Young-Soo PARK, Daejeon-si (KR); Sung-Hee KIM, Daejeon-si (KR); Young-Il KIM, Daejeon-si (KR); Cheol-Hye CHO, Daejeon-si (KR)

(72) Inventors: Young-Soo PARK, Daejeon-si (KR); Sung-Hee KIM, Daejeon-si (KR); Young-Il KIM, Daejeon-si (KR); Cheol-Hye CHO, Daejeon-si (KR)

(73) Assignee: Electronics and Telecommunications Research Institute, Daejeon (KR)

(21) Appl. No.: 13/547,912

(22) Filed: Jul. 12, 2012

(30) Foreign Application Priority Data
Feb. 22, 2012 (KR) 10-2012-0018137

(51) Int. Cl. G06F 21/20

(52) U.S. Cl. 726/23

(57) ABSTRACT

Provided is a security providing method based on a security breach in a security providing apparatus in which a physical device is virtualized so that a virtual machine monitor operates and is capable of working in a main domain and one or more sub domains. The method includes repairing sub domains experiencing security breaches; and updating security modules of the sub domains.

### CROSS-REFERENCE TO RELATED APPLICATION

This application claims the benefit under 35 U.S.C. §119(a) of Korean Patent Application No. 10-2012-0018137, filed on Feb. 22, 2012, the entire disclosure of which is incorporated herein by reference for all purposes.

### BACKGROUND

1. Field

The following description relates to virtualization technology, and more particularly, to an apparatus and a method for providing security in a virtualization device.

2. Description of the Related Art

Recently, virtualization technology, which abstracts a physical device and provides an independent operation environment, has been applied to cope with security-related problems due to real-time support, software re-use, and insecure program installation on diverse and complex mobile platforms.

Virtualization technology is widely used for server, desktop, embedded, and mobile virtualization, and can provide a new computing environment and simultaneously solve problems of an existing computing environment, such as information protection and resource management. It also simplifies a complex server computing environment and provides a cost saving effect by enhancing the efficiency of management and distribution of tasks to be processed.

Virtualization technology provides a characteristic of being able to divide a processing system into MVMs (Multiple Virtual Machines). For example, virtualization technology allows multiple operating systems to simultaneously operate on the same machine, so that hardware resources of the processing system can be divided and managed.

Meanwhile, a security module (program) inspects for security breaches (viruses, forgery, etc.) in applications and operating systems residing in memory, and applications and operating systems stored in a storage device, so that data can be repaired with the result. However, the security breach of operating systems can be transferred to security modules (programs) in the conventional technology, since applications operate on the same operating system. In addition, if all the data sent to the operating system from the I/O ports of hardware or memories is inspected by security modules (programs) in a virtual machine monitor, and infected data is repaired, performance decreases since the operating time of the virtual machine monitor increases.

Further, when using services provided by the operating system, since existing security modules (programs) operate on the operating system, services provided by the virtual machine monitor should be used to operate security modules (programs) on the virtual machine monitor, unlike the existing security modules (programs). However, since only a simple service for managing a virtual machine is provided, a security module (program) has to be changed in order to operate the security module (program) on the virtual machine monitor, and development costs can greatly increase since services provided by an existing operating system have to be reconfigured in a security module (program).

### SUMMARY

The following description relates to an apparatus and a method for providing security for virtualization that can rapidly repair infected data without a decrease in performance.

In one general aspect, the present invention provides an apparatus and a method for providing security for virtualization that do not increase development costs since there is no need to change a security module.

Further, the present invention provides a security providing apparatus that virtualizes a physical device that is a hardware resource. The apparatus includes one or more domains, each of which includes a guest operating system, operates through the physical device, and includes security modules for detecting and repairing a security breach, and a virtual machine monitor configured to be shared by the domains by virtualizing the physical device.

Further, the present invention provides a security providing method based on a security breach in a security providing apparatus in which a physical device is virtualized so that a virtual machine monitor operates and is capable of working in a main domain and one or more sub domains. The method includes repairing sub domains experiencing security breaches; and updating security modules of the sub domains.

Further, the present invention provides a security providing method of updating and downloading a guest operating system, a security module and applications of sub domains from an update server connected to a given communication network. The method includes determining whether to update one of the applications, the guest operating system and the security module of each of the sub domains, downloading the guest operating system or the security module from the update server and inspecting integrity thereof, and installing the downloaded guest operating system or the security module in the corresponding sub domain when the integrity inspection is complete.

Other features and aspects will be apparent from the following detailed description, the drawings, and the claims.

### BRIEF DESCRIPTION OF THE DRAWINGS

FIG. 1 is a diagram illustrating an example of a security providing apparatus according to an example embodiment of the present invention;

FIG. 2 is a diagram illustrating an example of logical layering of hardware and software architecture for an operating environment emulated in a domain;

FIG. 3 is a diagram illustrating an example of a security providing method based on a security breach according to an example embodiment of the present invention; and

FIG. 4 is a diagram illustrating an example of a security providing method based on an update request according to an example embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Example embodiments of the present invention will now be described in detail with reference to the attached drawings.

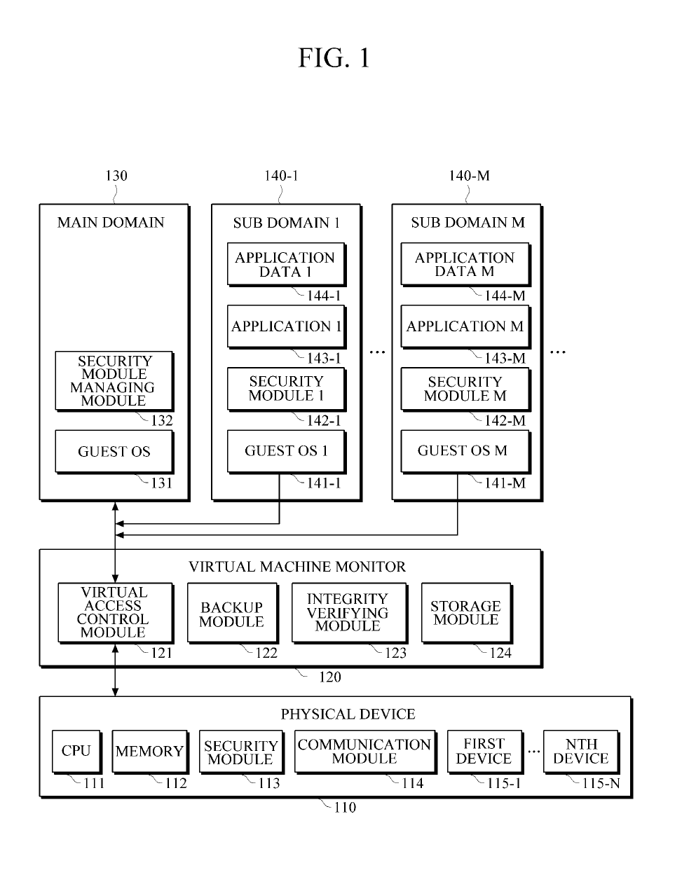

FIG. 1 shows a security providing apparatus according to an example embodiment of the present invention.

Referring to FIG. 1, the security providing apparatus according to an example embodiment of the present invention includes a physical device 110, a virtual machine monitor 120, a main domain 130, and one or more sub domains 140-1, . . . 140-M.

The physical device 110, which is a hardware resource, can be shared by a number of domains 130, 140-1, . . . 140-M through the virtual machine monitor 120, and includes a CPU 111, a memory 112, a security module 113, a communication module 114, and one or more devices 115-1, . . . 115-N. The physical device 110 in FIG. 1 is just an example and the present invention is not limited to it. In other words, the physical device 110 can further include resources such as two or more CPUs and cashes residing in corresponding CPUs and modules in which the same kinds of functions are differently realized.

The virtual machine monitor 120 is configured to be shared by the domains 130, 140-1, . . . 140-M through virtualization of the physical device 110. The security providing apparatus according to one embodiment of the present invention is based on an environment where a number of guest OSs 131, 141-1, . . . 141-M in the domains 130, 140-1, . . . 140-M can simultaneously operate through the virtual machine monitor 120.

The virtual machine monitor 120 in particular includes a virtual access control module 121, a backup module 122, an integrity verifying module 123, and a storage module 124.

The virtual access control module 121 controls operation of the guest OSs 131, 141-1, . . . 141-M in the domains 130, 140-1, . . . 140-M accessing the physical device 110 through the backup module 122, integrity verifying module 123, and storage module 124 of the virtual machine monitor 12. In addition, the virtual access control module 121 performs control so as to enable different setting of access authorities such as acceptable reference value, and allocation of the physical device 120 to a hardware for each domain 130, 140-1, . . . 140-M.

The backup module 122 recovers any domain that does not operate normally due to viral infection, so that the domain can operate normally. To do this, the backup module 122 can store normal state information while sub domains 140-1, . . . 140-M operate normally, and can generate domains for backup. A number of domains corresponding to the number of sub domains 140-1, . . . 140-M can be generated, or at least one domain can be generated.

The integrity verifying module 123 compares, when booting the sub domains 140-1, . . . 140-M, a first integrity verification value for the guest OSs 141-1, . . . 141-M of corresponding sub domains 140-1, . . . 140-M with a second integrity value stored in the storage module 124 to verify the integrity of the sub domains 140-1, . . . 140-M. The integrity of the sub domains 140-1, . . . 140-M is verified to determine deformation of the sub domains 140-1, . . . 140-M.

The storage module 124 stores data including security module state information and integrity verification values for the guest OSs 141-1, . . . 141-M, security modules 142-1, . . . 142-M, and applications 143-1, . . . 143-M in the sub domains 140-1, . . . 140-M.

The main domain 130 receives, installs and executes only integrity-verified software, since only integrity-verified software operates in the main domain. The main domain 130 can include a guest OS 131 and a security module managing module 132, which safely operate in a corresponding domain independently of the physical device 110.

The security module managing module 132 receives the verification result from the integrity verifying module 123 and enables the programs verified to be safely installed in the sub domains 140-1, . . . 140-M. The integrity verification is made by comparing, when booting the sub domain 1(140-1), a first integrity verification value for the guest OS(140-1) with a second integrity value stored in the storage module 124. In addition, the security module managing module 132 enables the guest OS, a program for a security module, and integrity-verified applications to be safely installed in corresponding sub domains and stores related information. The storage information can include policies such as program updates, and can periodically receive programs from servers through wired/wireless communication networks, although not shown in the Figures.

The sub domains 140-1, . . . 140-M can be two or more, and the guest OSs 141-1, . . . 141-M independently operate in each of the sub domains 140-1, . . . 140-M. The sub domains 140-1, . . . 140-M can suffer damage since typical applications capable of being infected by viruses at any time as well as integrity-verified applications are installed and executed in the sub domains, which are not secure from external attacks such as security breaches.

If a problem due to a security breach occurs, security inspection of a problematic domain is conducted with the security modules 142-1, . . . 142-M of the sub domains 140-1, . . . 140-M, which are independent.

A security module 1 142-1 to a security module 2 142-M are installed in each of the sub domains 140-1, . . . 140-M through the security module managing module 132 of the main module 130. The security providing apparatus according to the present invention installs security modules 142-1, . . . 142-M not in specific domains but in each domain according to the number of the number of a sub domain 1 140-1 and a sub domain M 140-M, which are independent.

The sub domain M 140-M also conducts repairs (virus repair, security breach recovery, etc.) on the sub domain 1 140-1, if an abnormal operation is detected from the sub domain 1 140-1 while inspecting and repairing a security breach in the sub domain M 140-M through the security module M 142-M. In other words, each security module installed in the sub domains 140-1, . . . 140-M can supplement one another.

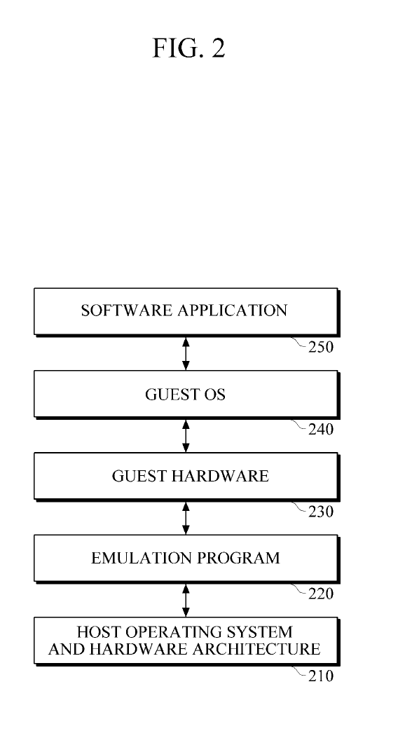

The detailed logical layer structure of the domains 130, 140-1, . . . 140-M will now be discussed with reference to FIG. 2.

FIG. 2 shows the logical layering of hardware and software architecture for an operating environment emulated in a domain.

An emulation program 220 is executed on a host operating system and/or hardware architecture 210. The emulation program 220 emulates guest hardware architecture 230 and a guest OS 240. In addition, an application 250 is executed on the guest OS 240.

Under the operating environment emulated in FIG. 2, due to the operation of the emulation program 220, an application 250 corresponding to applications 140-1, . . . 140-M installed in each of the sub domains 143-1, . . . 143-M can be executed on the security providing apparatus, even if it has been designed to be executed on an operating system that is not compatible with the host operating system and hardware architecture 210 in general.

A security providing method according to an example embodiment of the present invention can be divided into a process of updating according to a security breach and a process of updating according to an update request.

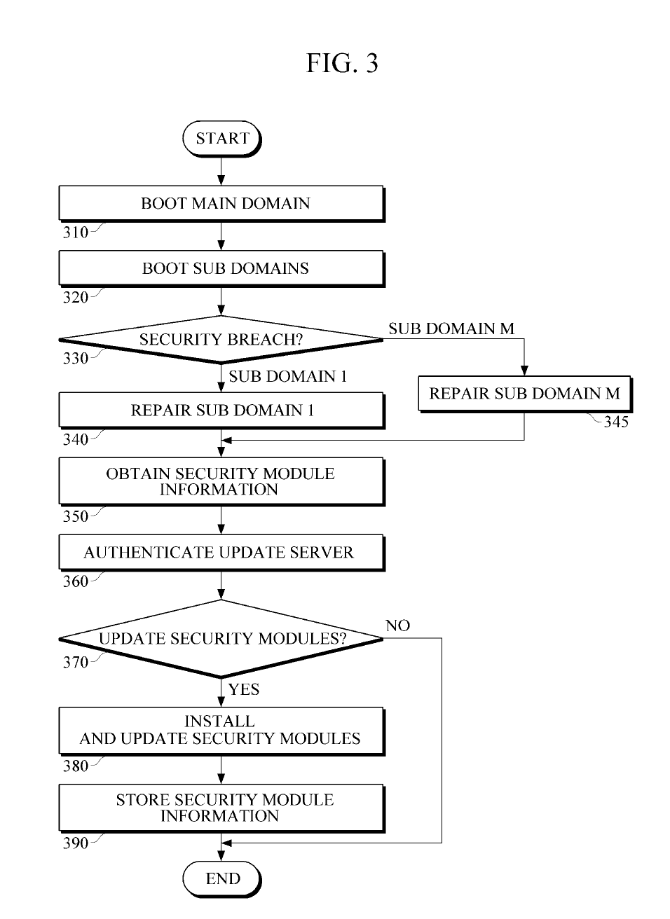

FIG. 3 shows a security providing method based on a security breach according to an example embodiment of the present invention.

Referring to FIG. 3, the security providing method is a method of updating the security modules 142-1, . . . 142-M of the sub domains 140-1, . . . 140-M. To do this, the virtual machine monitor 120 operates to virtualize the physical device 110, and the guest OS and the security module managing module operate through booting of the main domain 130 in operation 310.

If the main domain 130 boots in operation 310, then the guest OSs 141-1, . . . 141-M and the security modules 142-1, . . . 142-M in each of the sub domains 140-1, . . . 140-M operate through booting of the sub domains 140-1, . . . 140-M in operation 320.

If the main domain 130 and the sub domains 140-1, . . . 140-M boot, then it is determined in operation 330 whether there is security breach (viral infection) in the sub domains 140-1, . . . 140-M.

The determination about a security breach can be based on detection of abnormal operation in the sub domain 1 140-1 by the security module 1 142-1, in the sub domain M 140-M by the security module M 142-M, in the sub domain M 140-M by the security module 1 142-1, or in the sub domain 1 140-1 by the security module M 142-M.

As described above, if an abnormal operation in the sub domain 1 140-1 is detected through the determination, then the sub domain 1 140-1 is repaired by one of the security modules 142-1, . . . 142-M in operation 340. Or, if an abnormal operation in the sub domain M 140-M is detected, then the sub domain M 140-M is repaired by one of the security modules 142-1, . . . 142-M operating in a supplementary capacity in operation 345.

If the repairing of the sub domains 140-1, . . . 140-M is completed, then the security module managing module obtains state information about the security modules 142-1, . . . 142-M of the sub domains 140-1, . . . 140-M in operation 350. Obtaining the state information about the security modules 142-1, . . . 142-M can include periodically obtaining state information with a given period to update one or more of the security modules 142-1, . . . 142-M.

The security module managing module 132 which has obtained the state information authenticates an update server through a given communication network in operation 360.

If the update server is determined to be reliable, then the security module managing module 132 determines whether the security modules 142-1, . . . 142-M need updating in operation 370.

If it is determined in operation 370 that updating is needed, then the security module managing module 132 downloads security programs or update information requiring updating, verifies the integrity of the security programs downloaded, and installation or updating is carried out in operation 380.

If the installation or update of the security modules 142-1, . . . 142-M is completed, the security module managing module 132 stores and completes the information of the security modules in operation 390. Storing the information of the security module means storing an integrity verification value to inspect the security modules 142-1, . . . 142-M after installing or updating the security modules, and is preferably done in the storage module 124.

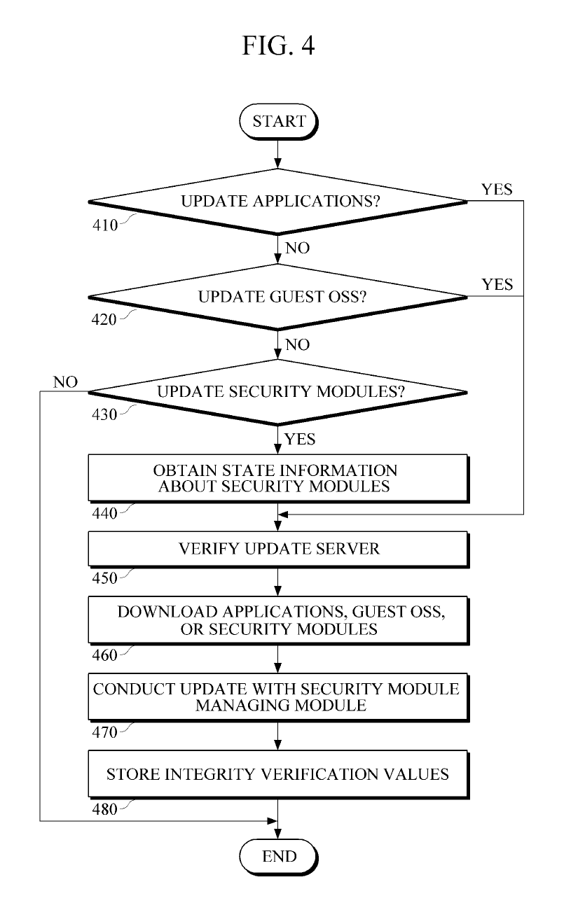

FIG. 4 shows a security providing method based on an update request according to an example embodiment of the present invention.

Updating according to one embodiment of the present invention is done by downloading update codes and data for the guest OS 1 to the guest OS M 141-1, . . . 141-M, the security module 1 to the security module M 142-1, . . . 142-M, or the applications 143-1, . . . 143-M of the sub domains 140-1, . . . 140-M, from the update server connected through a given communication network.

First, the security module managing module 132 determines whether to update the applications 143-1, . . . 143-M of each of the sub domains 140-1, . . . 140-M in operation 410.

If it is determined in operation 410 that there is no need to update the applications 143-1, . . . 143-M, then the security module managing module 132 determines whether to update the guest OS 1 to the guest OS M 141-1, . . . 141-M in operation 420.

If it is determined in operation 420 that there is no need to update the guest OS 1 to the guest OS M 141-1, . . . 141-M, then the security module managing module 132 determines whether to update the security module 1 to the security module M 142-1, . . . 142-M in operation 430.

If it is determined in any one of operations 410 to 430 that there is a need for updating, then the security module managing module 132 verifies whether an OS update server is correct.

If it is determined in operation 410 that there is a need to update the applications 143-1, . . . 143-M, then the security module managing module 132 verifies the integrity of the update server in operation 450.

If each update server is verified, then the security module managing module 132 downloads the guest OS or the security module from the update server and inspects their integrity.

If the integrity inspection of the guest OS or the security module downloaded from the update server is completed, the security module managing module 132 installs the guest OS or the security module in first to Mth sub domains 140-1, . . . 140-M, and stores integrity verification values for them in the storage module, in operation 480.

The present invention has an advantage of minimizing damage due to security breaches, since the present invention can rapidly recover operating systems and applications whose operations are stopped due to security breaches.

In addition, the present invention can minimize the time that can go unused by a user when a device operating system cannot be recovered due to security breaches, through rapid recovery.

In addition, a security problem due to a difference between information in a device for application virtualization and information in a real system can be solved. Information spillage can be blocked since when given registration information is registered with the operating system of a host device to execute stored application programs, the registration information can be automatically deleted upon completion of the applications.

In addition, domains where verified programs can operate are divided into a main domain and a general domain using a virtual machine monitor, updating of the security module in the general domain is done by the security module managing module of the main domain, the virtual machine monitor includes a security module to verify the integrity of the general domain, and key creation for the general domain and instrument (platform) authentication are performed.

In addition, the virtual machine monitor provides the same operations as the physical device, independently of an operating system and hardware.

While the invention has been described above by reference to various embodiments, it will be understood that changes and modifications may be made without departing from the scope of the invention, which is defined by the appended claims and their equivalents.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as those used in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A security providing apparatus that virtualizes a physical device that is a hardware resource, the apparatus comprising:
one or more domains, each of which comprises a guest operating system, operates through the physical device, and comprises security modules for detecting and repairing a security breach; and
a virtual machine monitor configured to be shared by the domains by virtualizing the physical device.

2. The apparatus of claim 1, wherein the domains comprise:
a main domain in which only verified software operates; and
one or more sub domains in which software integrity-verified by the main domain is installed.

3. The apparatus of claim 2, wherein the main domain comprises:
the guest operating system; and
a security module managing module configured to be controlled to safely install verified programs in the sub domains.

4. The apparatus of claim 2, wherein the sub domains comprise:
the guest operating system;
a security module configured to conduct security inspection on its own or other sub domains; and
an application configured to be operated by the guest operating system.

5. The apparatus of claim 4, wherein the virtual machine monitor comprises:
a virtual access control module;
a backup module configured to store normal state information during normal operation of the sub domain and generate backup information;
a storage module configured to store data including security module state information and an integrity verification value for the application, the security module, and the guest operating system in the sub domain; and
an integrity verifying module which when booting the sub domain compares a first integrity verification value for the guest operating system of a corresponding sub domain with a second integrity value stored in the storage module to verify the integrity of the sub domain.

6. The apparatus of claim 5, wherein the security module managing module compares a first integrity verification value for the guest operating system, the security module and the application with a second integrity value stored in the storage module to verify integrity when booting the sub domain.

7. The apparatus of claim 3, wherein the security module managing module periodically receives security modules or applications from servers through wired/wireless networks and installs them in the sub domain.

8. A security providing method based on a security breach in a security providing apparatus in which a physical device is virtualized so that a virtual machine monitor operates and is capable of working in a main domain and one or more sub domains, the method comprising:
repairing sub domains experiencing security breaches; and
updating the security modules of the sub domains.

9. The method of claim 8, wherein in the operation of repairing, the security modules included in one or more sub domains detect the states of sub domains including their own sub domain.

10. The method of claim 8, wherein in the operation of repairing, if abnormal operation is detected on the sub domain, a corresponding sub domain is repaired by one of the security modules.

11. The method of claim 8, wherein the updating comprises:
obtaining state information about the security modules of the sub domains;
authenticating an update server through a given communication network;
determining whether to update the security modules;
downloading security modules requiring updating, or update information from the server, if it is determined that updating is needed;
verifying the integrity of the downloaded security modules;
installing or updating the integrity-verified security modules; and
storing information about the security modules

12. The method of claim 11, wherein the obtaining of the state information comprises periodically obtaining state information about the security modules of the sub domains with a given period in order to update one or more of the security modules.

13. The method of claim 11, wherein the storing comprises storing an integrity verification value in a storage module of a virtual machine monitor to inspect the security modules.

14. A security providing method of updating one of a guest operating system, a security module, and applications of sub domains from an update server connected to a given communication network, the method comprising:
determining whether to update one of the applications, the guest operating system and the security module of each of the sub domains;
downloading one of the guest operating system, the security module and the applications from the update server and inspecting its integrity; and
installing the downloaded guest operating system, security module, or application in a corresponding sub domain.

15. The method of claim 14, further comprising:
storing the result for the integrity inspection.

16. The method of claim 14, further comprising:
verifying the update server if it is determined that updating is needed.

17. The method of claim 14, further comprising:
obtaining state information about the security module in the event that updating of the security module is requested.
